(19) United States
(12) Patent Application Publication
(10) Pub. No.: US 2010/0138507 A1
(43) Pub. Date: Jun. 3, 2010

(54) Method for processing pager model messages and user agent thereof

(75) Inventors: Qian Sun, Shenzhen (CN); Linyi Tian, Shenzhen (CN); Daqi Ren, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/631,145

(22) Filed: Dec. 4, 2009

Related U.S. Application Data
(63) Continuation of application No. PCT/CN2008/071109, filed on May 27, 2008.

(30) Foreign Application Priority Data
Jun. 5, 2007 (CN) 200710074737.8

(51) Int. Cl. G06F 15/16

(52) U.S. Cl. 709/206; 709/227

(57) ABSTRACT

A method for processing pager model messages is disclosed according to the present disclosure. The method includes receiving a first pager model message; receiving a second pager model message containing an indication of replacing the first pager model message; and replacing the first pager model message with the second pager model message according to the indication; returning a replacement result notification after replacement operation.

### CROSS-REFERENCE TO RELATED APPLICATIONS

This application is a continuation of International Application No. PCT/CN2008/071109, filed on May 27, 2008, which claims priority to Chinese Patent Application No. 200710074737.8, filed on Jun. 5, 2007, both of which are hereby incorporated by reference in their entireties.

### FIELD OF THE DISCLOSURE

The present disclosure relates to Session Initiation Protocol (SIP) in communication field, and more specifically, to pager model message MESSAGE in the Session Initiation Protocol.

### BACKGROUND

The pager model message, i.e., MESSAGE, in the current Session Initiation Protocol (SIP) is mainly employed to realize the transmission of instant messages. The details are defined in RFC3428. A typical flowchart of a MESSAGE message is illustrated in FIG. 1. The process mainly includes the following steps.

Step 101: A sender, i.e., a first user agent UA1, sends a MESSAGE message.

Step 102: A proxy server PROXY forwards the MESSAGE message to a receiver, i.e., a second user agent UA2.

Step 103: The second user agent UA2 returns a 200 OK response.

Step 104: The proxy server PROXY forwards the 200 OK response to the first user agent UA1

Because the MESSAGE message does not set up any session between the sender and the receiver, the MESSAGE message may also be referred to as a pager model message or pager message. In the process of implementing the present disclosure, it is discovered that the conventional art encounters at least the following defects. Currently, after the user sends a MESSAGE message, if the user found that the content of the message is not correct or the recipient is not the intended recipient, the transmitted MESSAGE message may not be recalled. In addition, the user or the service server may sometimes wish to replace the previously sent message with a message containing updated content. For instance, when the time and the place of an appointment indicated in the sent message is updated, it is desirable that the recipient does not need to read the previous message. However, this is currently infeasible.

### SUMMARY

In view of this, a method for processing pager model messages is proposed. According to the method, the previously sent pager model message may be updated or recalled.

Further, a method for updating an instant message is proposed. According to the method, the user is able to update the previously sent instant message.

A user agent is also provided according to the present disclosure. The user agent is able to update or delete the previous pager model message.

A method for processing pager model messages includes: (1) receiving a first pager model message; (2) receiving a second pager model message containing an indication of replacing the first pager model message; and (3) performing, according to the indication, a replacement operation on the first pager model message matching a message ID.

A method for replacing an instant message includes: (1) receiving a first instance message, wherein Common Presence and Instant Messaging content in the first instant message contains a message ID of the first instant message; (2) receiving a second instant message containing an indication of replacing the first instant message, wherein the indication contains a message ID corresponding to the first instant message; and (3) performing, according to the indication, a replacement operation on the first instant message matching a message ID.

A user agent includes: (1) a transmission processing module, configured to receive a Session Initiation Protocol (SIP) message sent by a message processing module and send out the SIP message by a corresponding bearer protocol; (2) the message processing module is configured to encode or decode the SIP message and perform transaction control; and (3) a replacement processing module, configured to interact with the message processing module and instruct the message processing module to incorporate a replacement indication in a message to be sent out; and/or receive the decoded and replacement disposition related message from the message processing module and perform a replacement operation.

According to the embodiments of the present disclosure, an indication of replacing a previous pager model message is included in a pager model message sent by the user agent. The replacement indication enables a user agent of a recipient to uniquely determine a previous pager model message. Thus, the user agent of the recipient may perform replacement operation according to the indication.

### BRIEF DESCRIPTION OF THE DRAWINGS

FIG. 1 is a basic flowchart of conventional message interaction during the transmission of the MESSAGE message;

FIG. 2 is a basic flowchart of replacing MESSAGE message according to a first embodiment of the present disclosure;

FIG. 3 is a basic flowchart of replacing group MESSAGE messages according to a third embodiment of the present disclosure; and

FIG. 4 is a block diagram of a user agent according to an embodiment of the present disclosure.

### DETAILED DESCRIPTION

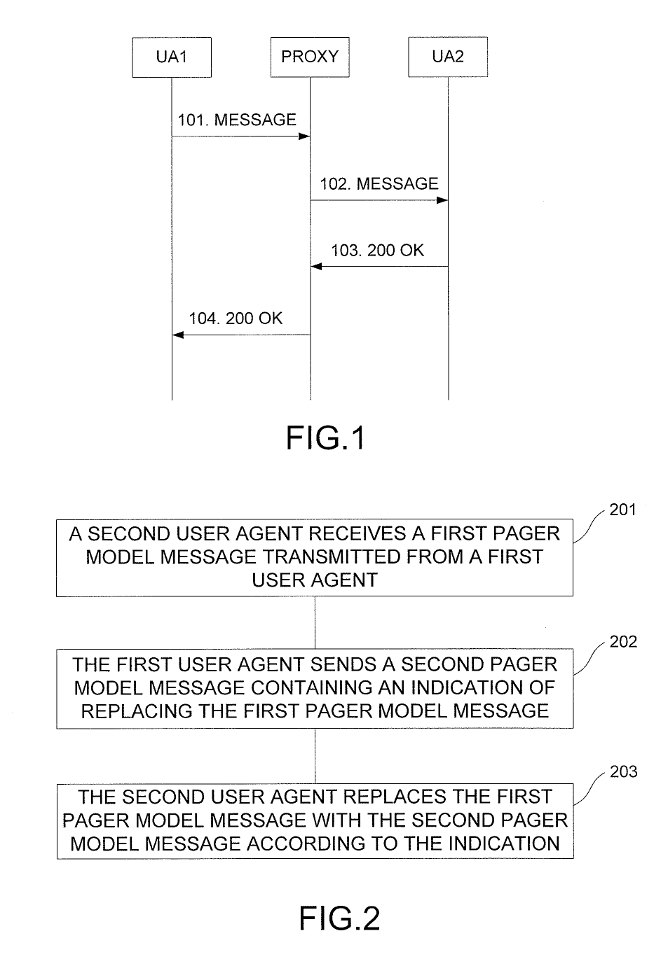

A first embodiment of the present disclosure describes how to replace a MESSAGE message. As illustrated in FIG. 2, the first embodiment includes the following steps.

Step 201: A second user agent UA2 receives a first pager model message transmitted from a first user agent UA1. The second user agent UA2 may be an ultimate receiver, which generally resides in a user terminal such as a cell phone or a personal computer. The ultimate receiver generally feeds back a 200 OK response upon receipt of the MESSAGE message. The second user agent UA2 may also be a Message Relay server of a network side. If the second user agent may not deliver the MESSAGE message to the ultimate receiver immediately upon receipt of the MESSAGE message, the second user agent may cache the message for later transmission, and return, at the same time, a 202 Accepted response to the sender, i.e., the first user agent UA1. An example of the content of the first pager model message is given below.

MESSAGE sip:user2@domain.com SIP/2.0
From: sip:user1@domain.com;tag=49583
To: sip:user2@domain.com
Call-ID: asd88asd77a@1.2.3.4
CSeq: 1 MESSAGE
Content-Type: text/plain
Content-Length: 18
Watson, come here.

Part of the message content is omitted for brevity. The Request URI in a start line of the message is an address of the ultimate receiver, which is “sip:user2@domain.com.” An address in the From header field is a logic address of the sender. An address in the To header field is a logic address of the ultimate receiver. The Call-ID header field contains a call ID. The CSeq header field contains a serial number for the transmitted MESSAGE message in the current conversation. In addition, a sender address (From header field) and the receiver address (To header field) each may contain a globally unique tag. Such globally unique tags and the Call-ID may share a same unique conversation, which is specified in RFC3261, Internet Engineering Task Force (IETF). The present embodiment of the disclosure fully utilizes the information in the existing fields, which may uniquely determine the characteristics of a pager model message. The content of the message body is a piece of text with a Content-Type of “text/plain”.

Step 202: The first user agent UA1 sends a second pager model message containing an indication of replacing the first pager model message. The second pager model message may be referred to as a replace message. For instance, when the user discovers that the message content he or she sent is incorrect, the user may wish to resend a MESSAGE message to replace the previous MESSAGE message so as to prevent the ultimate recipient from mistakenly reading the previous message content. An example of the replace message i.e., the second pager model message, is given below.

MESSAGE sip:user2@domain.com SIP/2.0
From: sip:user1@domain.com;tag=53568
To: sip:user2@domain.com
Call-ID: fgh11qwe22s@1.2.3.4
CSeq: 1 MESSAGE
Replaces: asd88asd77a@1.2.3.4;to-tag=0;from-tag=49583
Content-Type: text/plain
Content-Length: 31
Watson, I am coming to see you.

The Replaces header field (i.e., Replace header field) contains a call ID (Call-ID) of the first pager model message, for example, the above “asd88asd77a@1.2.3.4” and also contains the tags in the From header field and the To header field, i.e., from-tag=49583 and to-tag=0. When the tag in the Replaces header field is 0, it may correspond to the tag value in From and To header fields which is 0 or null. The logic addresses in the “From” and “To” header fields are similar to those of the first pager model message.

In addition, the value of “to-tag” in the Replaces header field may also be obtained from the To field in a 200 OK or 202 Accepted response to the first pager model message. Because there might probably be no corresponding value for the tag in the To header field of the first pager model message, if the To field in the response to the first pager model message contains a tag value, this value may be treated as the “to-tag” value for the second pager model message. When the logic address of the receiver corresponds to a plurality of registered physical addresses, the first pager model message might be branched. A user agent corresponding to each physical address may reply a corresponding response like 200 OK, with the tag in each To header field being different.

If a plurality of MESSAGE messages relating to a same conversation is sent, the indication information in the replace message may further contain a serial number of a message to be replaced so as to replace a particular MESSAGE message. An example of part of the contents of the first pager model message is given below.

MESSAGE sip:user2@domain.com SIP/2.0
From: sip:user1@domain.com;tag=49583
To: sip:user2@domain.com;tag=92321
Call-ID: asd88asd77a@1.2.3.4
CSeq: 3 MESSAGE

In this case, the Replaces header field containing the indication information in the second pager model message may include the following content.

Replaces: asd88asd77a@1.2.3.4;to-tag=92321;from-tag=49583;id=3

where the value of the serial ID parameter “id” is the same as the serial number in the CSeq header field in the first pager model message.

Step 203: The second user agent UA2 replaces the first pager model message which matches the message ID with the second pager model message according to the indication.

After the second user agent UA2 receives the second pager model message, the second user agent may immediately return a 200 OK or 202 Accepted response, informing the first user agent UA1 that the second user agent has successfully received the second pager model message, which, however, does not necessarily indicate a successful replacement. The second user agent UA2 determines a matching message according to the indication in the Replaces header field of the second pager model message and then performs a replacement operation on the matching message. For instance, the matching message may be deleted directly, or when the user browses or opens the matching message, the user is prompted that this message has been replaced with the second pager model message, or when the user browses or opens the second pager model message, the first pager model message which has been replaced is also displayed at the same time. If the second user agent UA2 determines more than one matching message according to the indication in the Replaces header field of the second pager model message, the message is preferably handled as if no matching message were found.

If the first user agent UA1 wants to recall the first pager model message (that is, delete both the first pager model message and the second pager model message) as a way to replace the message, this specific replacing manner may be specified in the second paging message sent at step 202. In this point, the second pager model message may be referred to as a recall message, which is a special replace message. For instance, the specific replacing manner may be specified in the Replaces header field as “recall”.

Replaces: asd88asd77a@1.2.3.4;to-tag=92321;
from-tag=49583;id=3;recall
Or, Replaces: asd88asd77a@1.2.3.4;to-tag=92321;
from-tag=49583;id=3;usage=recall

When the second user agent UA2 detects the specific replacing manner, which is to recall the message, is contained in the second pager model message, the second user agent UA2 may at the same time delete the messages, which match the second pager model message, i.e., the first paging model message and the second paging model message. The default manner for handling the replacement operation is to replace and update the message, which means that the second pager model message is used to update the first pager model message.

In addition, because the MESSAGE message may sometimes be cached in a server at the network side for storage and forwarding purpose, it is not certain as to whether the second user agent, as the ultimate receiver, will receive the original first pager model message first, or receive the replace message (i.e., the second pager model message) first. If the second user agent UA2 receives the second pager model message first, the second user agent UA2 may directly discard the first pager model message at the time of receiving the original first pager model message later on.

A second embodiment describes an instance where the content of the message body is in a Common Presence and Instant Messaging format which is called CPIM format. In addition, the second embodiment also describes how the user sending the replace message is informed of whether the replacement is successful or not. The first user agent UA1 incorporates an indication of an intention to acquire a replacement disposition notification in the replace message to be sent. In particular, the indication of an intention to acquire a replacement disposition notification may adopt an Instant Message Disposition Notification manner. Assuming that the message ID in the CPIM message body of the first pager model message is IMDN message ID “23gh123k.” An example of part of the contents of the message is given below.

MESSAGE sip:user2@domain.com SIP/2.0
Content-Type: Message/CPIM
NS: imdn <urn:ietf:params:imdn>
imdn.Message-ID: 23gh123k
imdn.Disposition-Notification: read

IMDN message ID is used for the sender to match the disposition notification. In addition to the IMDN message ID, a dedicated CPIM message ID header field “Msg-ID” may be provided. For instance, “Msg-ID” may be used to uniquely determine a transmitted CPIM message. In addition, it is desirable that the receiver may return an instant message read notification. That is, the header field of the disposition notification “imdn.Disposition-Notification” contains an indication of read notification “read”. Usually, the sender may send a replace message especially a recall message when the sender has not received the read notification. This is because the receiver does not need to recall the message if the message has been read already. The Replaces header field in the CPIM message body of the replace message, i.e., the second pager model message, may contain a corresponding message ID. An example of part of the contents of the replace message is given below.

MESSAGE sip:user2@domain.com SIP/2.0
Content-Type: Message/CPIM
Replaces: imdn-id=23gh123k
NS: imdn <urn:ietf:params:imdn>
imdn.Message-ID: 34jk324j
imdn.Disposition-Notification: replace

It is to be noted that the Replaces header field is the header field in the CPIM message body, rather than the header field in the MESSAGE message. The “imdn.Disposition-Notification” header field of the CPIM contains an indication of an intention to acquire replacement disposition notification, such as “replace.” If the disposition result is not required, each header field of IMDN may not need to be included in the CPIM message body. The specific CPIM format may refer to specification FRC 3862. The usage of CPIM imbues the instance message communication with a better interoperability. Further, the CPIM message body does not have to be carried by SIP MESSAGE message. It may be carried by virtue of other protocols such as HTTP, SMTP. The alternatives provided by the present embodiment may be applicable to any messaging service using CPIM, especially in the instant messaging service. The benefits of CPIM message are that different networks may communicate with each other via the instant messages. Although different network carries the instant message via different protocol, it is very easy to make conversion among the gateways of the networks as long as the message body employs the CPIM format.

The second user agent UA2 determines a matching message according to the indication information in the Replaces header field of the second pager model message (i.e., IMDN message ID) and performs a replacement operation for the matching message, where the matching message refers to the one which has the same message ID as in the “imdn.Message-ID” header field. Of course, the Replaces header field in the CPIM message body may also contain the specific replacing manner, such as recall the message.
Replaces: imdn-id=23gh123k;usage=recall

In addition, replacement indication information may also be contained in the header field of Content-Disposition in the CPIM message body. An example is given below.

Content-Type: Message/CPIM
Content-Disposition: recall; msgid=23gh123k

The specific replacing method in the replacement indication such as “recall” may indicate recalling a CPIM message, or “replace” may indicate updating a CPIM message. The message to be updated may be uniquely identified by a message ID parameter such as “message-id.” The previous message to be replaced may include the message ID header field or the message ID header field of IMDN in the CPIM message header field.

The second user agent UA2 may also return the result of replacement to the first user agent UA1 after the UA2 performs the replacement operation. The result may be contained in an IMDN message body which is sent to the first user agent UA1. An example of part of the contents of the message content is given below.

```
Content-type: message/imdn+xml
Content-Disposition: notification
<?xml version=“1.0” encoding=“UTF-8”?>
<imdn xlmns=“urn:ietf:params:xml:ns:imdn”>
      <message-id>34jk324j</message-id>
      <disposition><replace/></disposition>
      <status><replaced/></status>
</imdn>
```

The MESSAGE message may be used to carry the IMDN message body. Parts of the message body and message header are omitted herein for brevity. The value of element <message-id> in the IMDN message body whose content type is “message/imdn+xml” matches the “imdn.Message-ID” header field of the replace message. The element <disposition> and element <status> may be used to indicate that the disposition status is a successful replacement. If the recall is successful, the returned status may be <status><recalled/></status>. If no matching message is found, the returned status may be <status><notfound/></status>. If the second user agent forbids replacement, the returned status may be <status><forbidden/></status>. Other error may be returned as <status><error/></status>. In addition, the IMDN message body may further contain the sender ID and receiver ID, such as SIP URI, as well as time and notes of the replace message, etc.

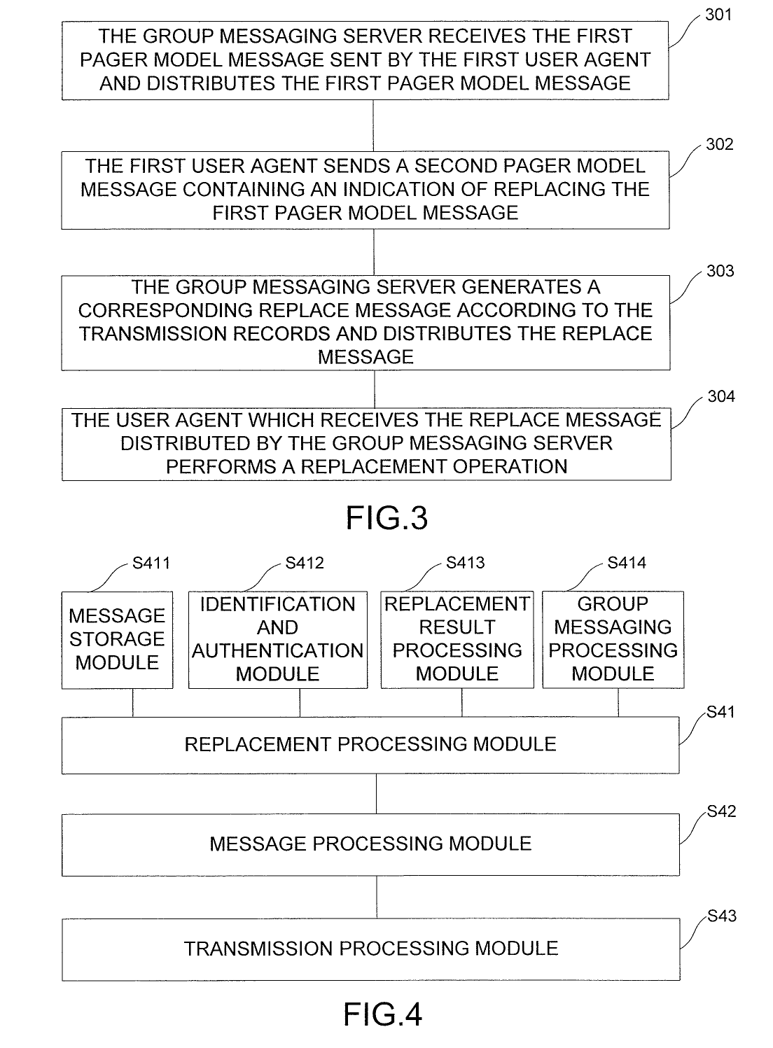

A third embodiment describes how to replace the group pager model messages. Referring to FIG. 3, following steps are included.

Step 301: The first user agent UA1 sends a first pager model message to the second user agent UA2, i.e., a group messaging server. The first pager model message may contain an address list (URI list) of the receivers. After receiving the message, the group messaging server distributes the message to each recipient in the URI list, such as a third user agent UA3 and a fourth user agent UA4. Assuming that the message sent to the third user agent is a distributed message A associated with the first pager model message, while the message sent to the fourth user agent is a distributed message B associated with the first pager model message. The first pager model message and each corresponding distributed message have different call IDs.

Step 302: The first user agent sends a second pager model message containing an indication of replacing the first pager model message. If the first user agent UA1 intents to only recall the pager model message sent to the third user agent, the first user agent UA1 may not only incorporate replacement indication in the Replaces header field of the transmitted the replace message (i.e., second pager model message), but also incorporate the URI list where replacement needs to be performed. If the Replaces header field is contained but the URI address where replacement needs to be performed is not contained, it means that all the distributed pager model messages need to be replaced. An example of the replace message containing the URI list to be replaced is given below.

MESSAGE sip:list-service.domain.com SIP/2.0
Replaces: asd88asd77a@1.2.3.4;to-tag=0;from-tag=49583;id=1
Content-Type: application/resource-lists+xml
Content-Disposition: recipient-list
<?xml version=“1.0” encoding=“UTF-8”?>
<resource-lists xmlns=“urn:ietf:params:xml:ns:resource-lists”><list>
<entry uri=“sip:user3@domain.com”/>
</list></resource-lists>

The request URI of the message is sip:list-service.domain.com, which corresponds to the group messaging server (MESSAGE URI-list Server). The message body contains an URI list where replacement needs to be performed, e.g., <entry uri=“sip:user3@domain.com”/>. The message body may further contain other content, such as information in plain text. Then, the message body which has a content type of “multipart/mixed” is used to contain these different types of contents. In addition, the Content-Disposition field which indicates the method for handling the URI list may also contain indication of replacing URI list, such as “replace-list”.

Step 303: The group messaging server generates a corresponding replace message according to the transmission records and distributes the replace message. The group messaging server receiving the replace message may determine the addresses where the replace message is to be distributed. If the replace message does not contain the URI list to be replaced, the replace message is distributed to all the distributed messages associated with the previous first pager model message. If the replace message contains the URI list to be replaced, the replace message is distributed to the recipients in the URI list. The distributed replace message generally contains other message body contents in addition to the URI list to be replaced.

The group messaging server generally records the correspondence between the first pager model message and each distributed message. When the group messaging server receives the replace message, i.e., the second pager model message, the group messaging server first determines the first pager model message in match according to the replacement indication contained in the Replaces header field of the replace message. Then, the ID corresponding to the distributed message associated with the first pager model message is contained in the Replaces header field of the generated distributed replace message. An example of part of the contents of the distributed message A associated with the first pager model message transmitted by the group messaging server to the third user agent UA3 is given below.

MESSAGE sip:user3@domain.com SIP/2.0
To: <sip:user3@domain.com>
From: user1<sip:user1@domain.com>;tag=210342
Call-ID: 39s02sds120d9sj21
CSeq: 1 MESSAGE

The Call-ID and From tag in the distributed message A is different from those of the first pager model message. An example of part of the contents of the distributed message associated with the corresponding replace message, i.e., the second pager model message, transmitted by the group messaging server to the third user agent UA3 is given below.

MESSAGE sip:user3@domain.com SIP/2.0
Replaces: 39s02sds120d9sj21;to-tag=0;from-tag=210342;id=1

Each ID in the Replaces header field corresponds to the distributed message associated with the first pager model message. That is, the group messaging server may not directly copy the Replaces header field in the replace message sent by the first user agent UA1, but has to match the corresponding distributed message according to the message distribution record stored in the group messaging server and generate an ultimate Replaces header field based on the information in the distributed message, such as Call-ID. Therefore, the group messaging server does not directly distribute the replace message. Rather, the group messaging server converts the Replaces header field before distributing the replace message. If the group messaging server has not saved any message distribution record, the group messaging server may return a notification to the first user agent, informing that replacement may not be performed.

If the group messaging server has not started to distribute the first pager model message before receiving the corresponding replace message, the group messaging server may directly distribute the corresponding replace message. In the case of recalling a message, the distribution of the first pager model message is cancelled. If the replace message contains a URI list, the above processing should only be focused on the ones that are included in the URI list. For example, the message will be not distributed to a specified URI list or the replace message is distributed to a specified URI list but the original first pager model message is still distributed to the remaining addresses. The group messaging server may also return a replacement disposition notification to the first user agent. The replacement disposition notification may contain the URI list and corresponding disposition result.

Step 304: The user agent like the third user agent UA3 which receives the replace message distributed by the group messaging server performs a corresponding replacement operation, which is similar to the one in the first embodiment. Therefore, the replacement operation will not be repeated herein.

If the second pager model message also contains an indication of an intention to acquire a replacement disposition notification, the group messaging server should copy the indication in the distributed replace messages. The replacement disposition notification returned by the ultimate receiver may be directly sent to the first user agent. That is, the notification is sent to the logic address in the “From” header field, rather than sent to the group messaging server.

No matter it is to replace the message or recall the message, it is better to provide a security mechanism so as to prevent an attacker from maliciously deleting or tampering with the message already received by the user. A security mechanism provided by SIP may be used to verify the identity of the sender of the replace message. For instance, the security mechanism may be Digest or signing Secure/Multipurpose Internet Mail Extensions, etc., which is specified in RFC3261. In addition, in a trust domain, a P-Asserted-Identity header field may also be used to identify the sender of the replace message, which is specified in RFC3325.

Generally, the sender of the first pager model message and the sender of the second pager model message are the same one. That is, the logic addresses in the From header fields of the two messages are usually the same. Of course, the embodiments of the present disclosure may also be applicable to different users. As long as the receiver trusts the sender of the replace message and identifies the identity, corresponding replacement operation may be performed; otherwise, a forbidden response may be returned to the sender or the sender is asked to go through an authentication. The receiver may also be configured with some local policies for authentication, for instance, local policies like if it is allowed to perform replacement, or the replace messages from which users are allowed to be received, or if it is allowed to perform a recall operation, etc.

It is appreciated by those skilled in the art that the entire or partial steps in the above method embodiments may be implemented with hardware when instructed by programs. Such programs may be stored in a computer readable storage media. When the program is being executed, the steps in the above method embodiments are executed. The storage media may include various media which store the program codes such as ROM, RAM, magnetic disc, or optical disc, etc.

As illustrated in FIG. 4, the user agent according to the present embodiments may contain three basic modules: a transmission processing module S43, a message processing module S42, and a replacement processing module S41. The transmission processing module is configured to receive an SIP message sent from the message processing module in an upper layer and send out the SIP message in accordance with a corresponding bearer protocol, such as User Datagram Protocol (UDP) or Transmission Control Protocol (TCP). The message processing module is configured to encode or decode the SIP message and perform transaction control, etc. The replacement processing module is configured to process the message containing the replacement indication as follows: encoding or decoding the replacement disposition related message encoded or decoded via the message processing module and managing related transaction. The replacement processing module may inform the message processing module that a pager model message to be sent contains replacement indication, or receive replacement disposition related messages decoded by the message processing module, and perform replacement operation on the message, such as generate a corresponding replace message or generate a replacement result notification message, etc. The replacement processing module may interact with a message storing module S411, an identifying and authenticating module S412, a replacement result processing module S413, a group messaging processing module S414, etc., so as to accomplish corresponding functions. For instance, the call ID or message ID, etc., of the sent message may be acquired via the message storing module so that replacement indication in the corresponding replace message is generated. The replacement processing module invokes the message processing module to encode the generated replace message and generate a corresponding transaction. The replace message is ultimately sent out via the transmission processing module by virtue of a protocol such as UDP or TCP. The message storing module is mainly configured to store the sent or received message and provide the information of the stored message to the replacement processing module and replace the stored message according to the indication from the replacement processing module.

An identifying and authenticating module is configured to add signature information or receive identity verification in a replace message to be sent by the replacement processing module, or identify or authenticate a received replace message, etc. In addition, the replacement result processing module may also generate a corresponding replacement result notification message based on the completed replacement operation. Alternatively, when the user agent serves as a group messaging server, the group messaging server may generate distributed replace messages based on the received replace message. Then, the distributed replacement messages are distributed to a plurality of recipients by the replacement processing module. The plurality of recipients may be the ones in the specified URI list or the ones in the receiver list in the replace message.

Generally, the user agent actually possesses the processing ability of both the sender and the receiver such as UA1, UA2, and UA3 mentioned in the above embodiments. The user agent may be located in a user terminal such as a cell phone, a personal computer, etc, or may be located in an application server.

Apparently, any variations or modifications may be readily appreciated by those skilled in the art without departing from the spirit and scope of the present disclosure. As such, if these variations or modifications fall within the scope of the claims of the present disclosure and the equivalent techniques, these variations or modifications are intended to be included in the present disclosure.

What is claimed is:

1. A method for processing pager model messages, comprising:
receiving a first pager model message;
receiving a second pager model message containing an indication of replacing the first pager model message; and
performing, according to the indication, a replacement operation on the first pager model message matching a message ID.

2. The method of claim 1, wherein the indication is the content of a replace header field in the second pager model message.

3. The method of claim 2, wherein the step of receiving the second pager model message containing the indication of replacing the first pager model message comprises:
receiving the second pager model message containing the indication of replacing the first pager model message, wherein the replace header field in the second pager model message contains a call ID, a sender address tag and a receiver address tag of the first pager model message;
the step of performing, according to the indication, the replacement operation on the first pager model message matching the message ID comprises:
replacing the first pager model message whose call ID, sender address tag and receiver address tag match corresponding values of the replace header field in the second pager model message.

4. The method of claim 2, wherein the step of receiving the second pager model message containing the indication of replacing the first pager model message comprises: receiving the second pager model message containing the indication of replacing the first pager model message, wherein the replace header field in the second pager model message contains a call ID, a sender address tag, a receiver address tag and a message serial number of the first pager model message;
the step of performing, according to the indication, the replacement operation on the first pager model message matching the message ID comprises:
replacing the first pager model message whose call ID, sender address tag, receiver address tag and message serial number match corresponding values of the replace header field in the second pager model message.

5. The method of claim 1, wherein the indication further comprises information indicating that the replacing method is a recall operation;
the step of performing, according to the indication, the replacement operation on the first pager model message matching the message ID comprises: deleting the first pager model message and the second pager model message.

6. The method of claim 1, wherein the first pager model message comprises an Instant Message Disposition Notification message ID;
the step of receiving the second pager model message containing the indication of replacing the first pager model message comprises:
receiving the second pager model message containing the indication of replacing the first pager model message, wherein the replace header field in Common Presence and Instant Messaging content of the second pager model message contains the Instant Message Disposition Notification message ID of the first pager model message;
the step of performing, according to the indication, the replacement operation on the first pager model message matching the message ID comprises:
replacing the first pager model message matching the Instant Message Disposition Notification message ID in the second pager model message with the second pager model message.

7. The method of claim 6, wherein the second pager model message further comprises an indication of an intention to acquire a replacement disposition notification; and
after the step of performing, according to the indication, the replacement operation on the first pager model message matching the message ID, the method further comprises: returning a corresponding replacement result notification in response to the replacement disposition notification.

8. The method of claim 1, wherein the first pager model message contains an address list and the method further comprises sending the first pager model message to addresses specified in the address list;
the step of performing, according to the indication, the replacement operation on the first pager model message matching the message ID comprises:
distributing, if the second pager model message contains a designated address list, a replace message to addresses specified in the designated address list in the second pager model message, wherein the replace message is a message obtained after the second pager model message is processed.

9. The method of claim 5, wherein the first pager model message contains an address list and the method further comprises sending the first pager model message to addresses specified in the address list;
the step of performing, according to the indication, the replacement operation on the first pager model message matching the message ID comprises:
distributing, if the second pager model message contains a designated address list, a replace message to addresses specified in the designated address list in the second pager model message, wherein the replace message is a message obtained after the second pager model message is processed.

10. The method of claim 6, wherein the first pager model message contains an address list and the method further comprises sending the first pager model message to addresses specified in the address list;
the step of performing, according to the indication, the replacement operation on the first pager model message matching the message ID comprises:
distributing, if the second pager model message contains a designated address list, a replace message to addresses specified in the designated address list in the second pager model message, wherein the replace message is a message obtained after the second pager model message is processed.

11. The method of claim 1, wherein the first pager model message sent by a first user agent contains an address list and the method further comprises sending the first pager model message to addresses specified in the address list;
the step of performing, according to the indication, the replacement operation on the first pager model message matching the message ID comprises:
distributing, if the second pager model message does not contain an address list, a replace message to addresses specified in an address list in the first pager model message, wherein the replace message is a message obtained after the second pager model message is processed.

12. The method of claim 5, wherein the first pager model message sent by a first user agent contains an address list and the method further comprises sending the first pager model message to addresses specified in the address list;
the step of performing, according to the indication, the replacement operation on the first pager model message matching the message ID comprises:
distributing, if the second pager model message does not contain an address list, a replace message to addresses specified in an address list in the first pager model message, wherein the replace message is a message obtained after the second pager model message is processed.

13. The method of claim 1, wherein the first pager model message contains an address list and the method further comprises receiving the second pager model message prior to sending the first pager model message to addresses specified in the address list;
the step of performing, according to the indication, the replacement operation on the first pager model message matching the message ID comprises:
directly distributing a corresponding replace message to the addresses specified in the address list wherein the replace message is a message obtained after the second pager model message is processed; or
cancelling the sending of the first pager model message.

14. The method of claim 8, further comprising directly returning, by a user agent receiving the distributed replace message, a replacement disposition notification to a first user agent.

15. A method for replacing an instant message, comprising:
receiving a first instance message, wherein Common Presence and Instant Messaging content in the first instant message contains a message ID of the first instant message;
receiving a second instant message containing an indication of replacing the first instant message, wherein the indication contains a message ID corresponding to the first instant message;
performing, according to the indication, a replacement operation on the first instant message matching a message ID.

16. The method of claim 15, wherein the indication is contained in a replace header field in the Common Presence and Instant Messaging content; or the indication is contained in a Content-Disposition header field.

17. The method of claim 15, wherein,
the sent second instant message further comprises an indication of an intention to acquire a replacement disposition notification;
after the step of performing, according to the indication, the replacement operation on the first instant message matching the message ID, the method further comprises:
returning a corresponding replacement result notification.

18. A user agent, comprising:
a transmission processing module, configured to receive a Session Initiation Protocol (SIP) message sent by a message processing module and send out the SIP message by a corresponding bearer protocol;
the message processing module, configured to encode or decode the SIP message and perform transaction control;
a replacement processing module, configured to interact with the message processing module and instruct the message processing module to incorporate indications in a message to be sent out; and/or receive the decoded and replacement disposition related message from the message processing module and perform a replacement operation.

19. The user agent of claim 18, further comprising at least one of the following modules:
a message storing module, configured to store a sent or received message, provide information of the stored message to the replacement processing module and replace the stored message according to the indication from the replacement processing module;
an identifying and authenticating module, configured to add signature information or receive identity verification in a replace message to be sent by the replacement processing module, or identify or authenticate a received replace message;
a replacement result processing module, configured to generate a corresponding replacement result notification based on the replacement operation completed, wherein the replacement result notification is sent out by the replacement processing module;
a group messaging processing module, configured to generate, based on the received replace message, a distributed message sent to addresses in a designated address list, wherein the distributed message is sent out by the replacement processing module.
